(19) United States
(12) Patent Application Publication
(10) Pub. No.: US 2015/0254528 A1
(43) Pub. Date: Sep. 10, 2015

(54) APPARATUS FOR PROVIDING THREE-DIMENSIONAL MINI-MAP SERVICE FOR SPORTS BROADCASTING

(71) Applicant: REALHUB CORP., LTD., Busan (KR)

(72) Inventors: Kang-seok Lee, Busan (KR); Jeong-hyun Kim, Busan (KR)

(73) Assignee: REALHUB CORP., LTD.

(21) Appl. No.: 14/564,383

(22) Filed: Dec. 9, 2014

(30) Foreign Application Priority Data
Mar. 5, 2014 (KR) 10-2014-0026241

(51) Int. Cl. G06K 9/62; G06T 5/00

(52) U.S. Cl. CPC G06K 9/6232; G06T 5/006; G06T 2207/30224; G06T 2207/30228

(57) ABSTRACT

Disclosed herein is an apparatus for providing a 3D mini-map service for sports broadcasting. The apparatus includes an image obtaining unit configured to obtain a field image frame, an image correcting unit configured to extract line information by tracking the line included in the field image frame, and to generate a corrected-image frame, an image analyzing unit configured to extract region information of the objects shown on the corrected-image frame and to analyze attribute information of the objects together with motion information of the objects, a mini-map generating unit configured to generate a 2D mini-map by displaying the region information of the objects together with the line information, a feature region display unit configured to display, on the 2D mini-map, a first region and a second region, and a 3D transforming unit configured to transform the 2D mini-map into a 3D mini-map.

### REFERENCE TO RELATED APPLICATIONS

This application claims the priority benefit of Korean Patent Application No. 10-2014-0026241, filed on Mar. 5, 2014, the entire contents of which are incorporated herein by reference.

### FIELD OF THE INVENTION

The present invention relates generally to an apparatus for providing a three-dimensional (3D) mini-map service for sports broadcasting and, more particularly, to an apparatus for providing a 3D mini-map service for sports broadcasting, by which a 3D mini-map indicating a position of every player in a field is generated and provided during sports broadcasting.

### BACKGROUND OF THE INVENTION

Generally, a sports broadcasting system obtains field images from a plurality of image obtaining devices installed in a stadium and transmits the obtained field images to a broadcasting station, which then processes the field images into a relay broadcast image to format them for a broadcasting form and broadcasts the relay broadcast image to a Television (TV), a cellular phone, or the like.

However, the relay broadcast image from the sports broadcasting system selectively shows only main parts of the field in most of the time, and rarely shows the entire field.

That is, the relay broadcast image mainly includes close-up images of some players and parts of the field where a ball is situated and there is no way to know the positions of the other players not shown on the relay broadcast image, making it difficult for viewers to correctly recognize and predict the overall flow of the match.

### SUMMARY OF THE INVENTION

Accordingly, the present invention has been made keeping in mind the above problems occurring in the prior art, and an object of the present invention is to provide an apparatus for providing a 3D mini-map service for sports broadcasting, by which a viewer may check the position of every player in a field, separately from a relay broadcast image during sports broadcasting and may easily recognize and predict the overall flow of the match, thus watching the match in an interesting manner.

Other objects to be provided in the present invention may be understood by an embodiment described below.

In order to accomplish the above object, the present invention provides an apparatus for providing a three-dimensional (3D) mini-map service for sports broadcasting, the apparatus including an image obtaining unit configured to obtain a field image frame by imaging a field in which objects including a plurality of players and one ball exist in such a way to include a line of the field, an image correcting unit configured to extract line information by tracking the line included in the field image frame obtained by the image obtaining unit, and to generate a corrected-image frame by correcting distortion of the field image frame using the extracted line information, an image analyzing unit configured to extract region information of the objects shown on the corrected-image frame generated by the image correcting unit and to analyze attribute information of the objects together with motion information of the objects from the extracted region information of the objects, a mini-map generating unit configured to generate a two-dimensional (2D) mini-map by displaying the region information of the objects together with the line information shown on the corrected-image frame generated by the image correcting unit in such a way to correspond to motion information of the objects and attribute information of the objects, a feature region display unit configured to display, on the 2D mini-map generated by the 2D mini-map generating unit, a first region including region information of an object identified as the ball among the objects based on the attribute information of the objects, and a second region, which is a remaining region other than the first region, in such a way to distinguish the first region from the second region, and a 3D transforming unit configured to transform the 2D mini-map into the 3D mini-map by replacing the region information of the objects shown on the 2D mini-map in which the first region and the second region are displayed distinctively from each other by the feature region display unit, with 3D region information using 3D vector information that is preset corresponding to the attribute information of the objects.

The apparatus may further include a relay broadcast image receiving unit configured to receive a relay broadcast image of the field, which is broadcast from a broadcasting station and an image merging unit configured to merge the relay broadcast image received by the relay broadcast image receiving unit with the 3D mini-map generated by the 3D transforming unit in such a way that the relay broadcast image includes the 3D mini-map, by reducing a size of the 3D mini-map to a preset size and overlapping the size-reduced 3D mini-map on the relay broadcast image based on preset pixel coordinate values of the relay broadcast image.

The apparatus may further include an image broadcasting unit configured to broadcast the relay broadcast image including the 3D mini-map, merged by the image merging unit, through the broadcasting station.

The image correcting unit may include an image transforming unit configured to transform the field image frame into a binary image frame based on a preset threshold value, a line extracting unit configured to extract the line information by tracking the line shown on a specific position in each frame from the binary image frame transformed by the image transforming unit, a distortion information analyzing unit configured to analyze distortion information of the field image frame based on the line information extracted by the line extracting unit, and a corrected-image generating unit configured to generate the corrected-image frame by correcting the field image frame to correspond to the distortion information analyzed by the distortion information analyzing unit.

The image analyzing unit may include a pixel detecting unit configured to detect a plurality of pixels having pixel values changing with a frame on a pixel region of the field image frame, an object extracting unit configured to extract the region information of the objects in a quadrilateral form by connecting the plurality of pixels detected by the pixel detecting unit in top/bottom/left/right directions, a motion analyzing unit configured to analyze the motion information of the objects based on a form in which the region information of the objects extracted by the object extracting unit changes with a frame of the field image frame, and an attribute analyzing unit configured to analyze the attribute information of the objects based on pixel sizes and the pixel values of the region information of the objects extracted by the object extracting unit.

The 2D mini-map generating unit may include a background image generating unit configured to generate a background image frame having a size corresponding to the corrected-image frame, a line display unit configured to display the line information on the background image frame generated by the background image generating unit, and an object display unit configured to display the region information of the objects on the background image frame generated by the background image generating unit in such a way to correspond to the motion information of the objects and the attribute information of the objects.

The feature region display unit may include an object identifying unit configured to compare pixel sizes of the region information of the objects and to identify an object having the smallest size as the ball, a region dividing unit configured to divide the field into the first region including the object identified as the ball and the second region, which is a remaining region other than the first region, and a pixel value changing unit configured to change the pixel values of the first region divided by the region dividing unit in such a way to distinguish the first region from the second region.

The 3D transforming unit may include a vector storing unit configured to store a plurality of pieces of 3D vector information, a vector matching unit configured to match 3D vector information corresponding to the attribute information of the objects among the plurality of pieces of 3D vector information stored in the vector storing unit, and a vector mapping unit configured to replace the 3D vector information matched by the vector matching unit with 3D region information by applying the matched 3D vector information to the region information of the objects.

Other aspects, advantages, and salient features of the invention will become apparent to those skilled in the art from the following detailed description, which, taken in conjunction with the annexed drawings, discloses various embodiments of the present invention.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating the entire structure of an apparatus for providing a three-dimensional (3D) mini-map service for sports broadcasting according to an exemplary embodiment of the present invention;

FIG. 2 is a block diagram illustrating an image correcting unit of an apparatus for providing a 3D mini-map service for sports broadcasting according to an exemplary embodiment of the present invention;

FIG. 3 is a block diagram illustrating an image analyzing unit of an apparatus for providing a 3D mini-map service for sports broadcasting according to an exemplary embodiment of the present invention;

FIG. 4 is a block diagram illustrating a two-dimensional (2D) mini-map generating unit of an apparatus for providing a 3D mini-map service for sports broadcasting according to an exemplary embodiment of the present invention;

FIG. 5 is a block diagram illustrating a feature region display unit of an apparatus for providing a 3D mini-map service for sports broadcasting according to an exemplary embodiment of the present invention; and

FIG. 6 is a block diagram illustrating a 3D transforming unit of an apparatus for providing a 3D mini-map service for sports broadcasting according to an exemplary embodiment of the present invention.

Throughout the drawings, like reference numerals will be understood to refer to like parts, components, and structures.

### DETAILED DESCRIPTION OF THE INVENTION

Hereinafter, an exemplary embodiment of the present invention will be described in detail with reference to the attached drawings.

Reference now should be made to the drawings, in which the same reference numerals are used throughout the different drawings to designate the same or similar components.

An apparatus for providing a three-dimensional (3D) mini-map service for sports broadcasting according to the present invention allows a viewer to check a position of every player in a field, separately from a relay broadcast image during sports broadcasting.

That is, a 3D mini-map showing a field including lines and all players and a ball in the field in a background image frame is generated to be smaller in size than a relay broadcast image and is then provided.

Thus, by viewing the 3D mini-map while watching a relay broadcast image broadcast from a broadcasting station, the viewer may know the positions of players not shown on the relay broadcast image, thus watching sports broadcasting in an interesting manner.

In addition, an apparatus for providing a 3D mini-map service for sports broadcasting according to the present invention may predict a region where players shown on the relay broadcast image are positioned and show the region in the 3D mini-map in such a way that the region may be distinguished from the other regions.

Thus, the viewer may easily know where the players shown on the relay broadcast image are positioned on the 3D mini-map, easily recognizing the flow of the match.

Hereinafter, an exemplary embodiment of the present invention will be described in detail with reference to the accompanying drawings.

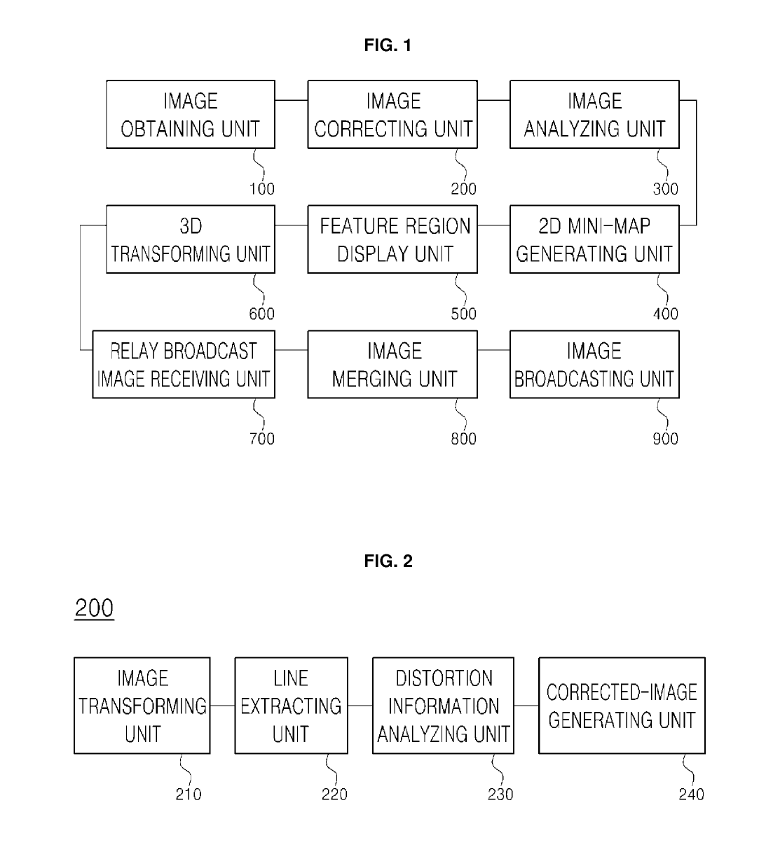

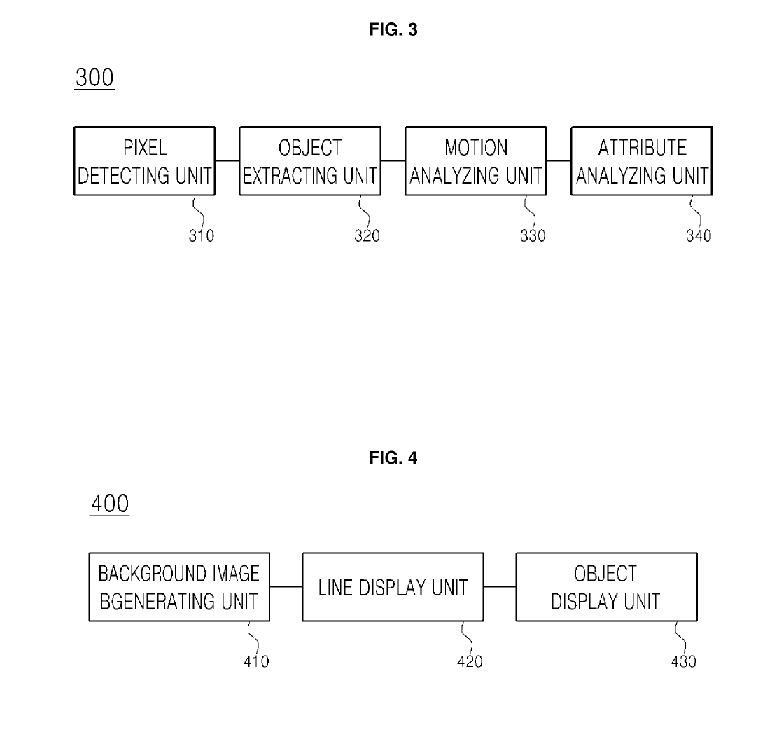

FIG. 1 is a block diagram illustrating the entire structure of an apparatus for providing a three-dimensional (3D) mini-map service for sports broadcasting according to an exemplary embodiment of the present invention. FIG. 2 is a block diagram illustrating an image correcting unit of the apparatus for providing a 3D mini-map service for sports broadcasting according to an exemplary embodiment of the present invention. FIG. 3 is a block diagram illustrating an image analyzing unit of the apparatus for providing a 3D mini-map service for sports broadcasting according to an exemplary embodiment of the present invention.

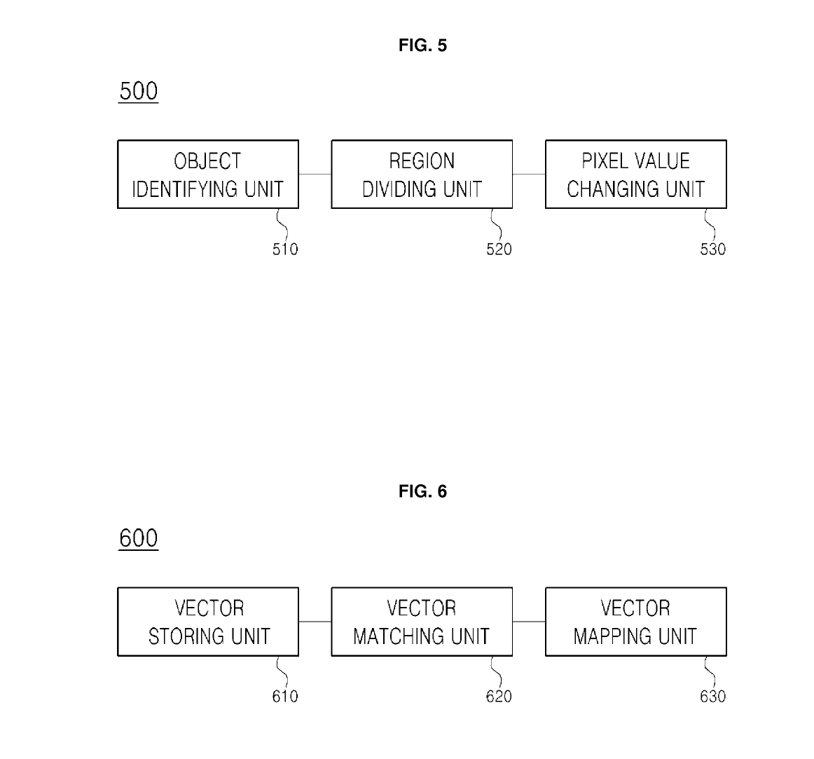

FIG. 4 is a block diagram illustrating a two-dimensional (2D) mini-map generating unit of the apparatus for providing a 3D mini-map service for sports broadcasting according to an exemplary embodiment of the present invention. FIG. 5 is a block diagram illustrating a feature region display unit of the apparatus for providing a 3D mini-map service for sports broadcasting according to an exemplary embodiment of the present invention. FIG. 6 is a block diagram illustrating a 3D transforming unit of the apparatus for providing a 3D mini-map service for sports broadcasting according to an exemplary embodiment of the present invention.

The apparatus for providing a 3D mini-map service for sports broadcasting according to an exemplary embodiment of the present invention may include an image obtaining unit 100, an image correcting unit 200, an image analyzing unit 300, a two-dimensional (2D) mini-map generating unit 400, a feature region display unit 500, and a three-dimensional (3D) transforming unit 600, as illustrated in FIG. 1.

First, the image obtaining unit 100 images a field to include lines of the field, thus obtaining a field image frame.

That is, the field image frame is obtained by imaging the entire field to include lines of the field through an image obtaining device installed above the field. To obtain the field image frame with minimum distortion, the image obtaining device is installed above the field.

In this case, lines, a plurality of players belonging to a first team or a second team, and one ball for a match among the players exist in the field, such that a field image frame obtained by the image obtaining device shows all of the lines, the players, and the ball.

Next, the image correcting unit 200 corrects distortion of the field image frame obtained from the image obtaining unit 100.

That is, lines corresponding to feature information shown on the field image frame are tracked to extract line information, and the distortion of the field image frame is corrected using the line information to generate a corrected image frame.

The image correcting unit 200 may include an image transforming unit 210, a line extracting unit 220, a distortion information analyzing unit 230, and a corrected-image generating unit 240, as illustrated in FIG. 2.

The image transforming unit 210 transforms the field image frame into a binary image frame based on a preset threshold value. The threshold value is set to a pixel value that makes a line of the field distinct in the binary image frame, according to the quality of the field image frame, which is affected much by illumination conditions of the field.

The line extracting unit 220 tracks the line in the binary image frame to extract line information. That is, the line extracting unit 220 obtains the line information by tracking all lines in the field.

The distortion information analyzing unit 230 analyzes distortion information of the field image frame by using the line information. That is, the distortion information analyzing unit 230 computes the distortion information of the field image frame based on a deviation of an angle between an outermost located horizontal component, which is information of a pair of side lines, and an outermost located vertical component, which is information of a pair of end lines, from a right angle, and a difference between a length ratio between the side line and the end line and a length ratio between a side line and an end line of a real field, out of the line information.

The corrected-image generating unit 240 generates a corrected image frame by correcting a field shown on the field image frame in the form of a rectangle according to the distortion information of the field image frame. In this case, when distortion of the field image frame is corrected, interpolation may be used to prevent degradation of image quality.

Next, the image analyzing unit 300 analyzes motion information and attribute information of objects including a plurality of players and one ball shown on the corrected image frame corrected by the image correcting unit 200.

More specifically, the image analyzing unit 300 extracts region information of objects shown on each frame from the corrected image frame to analyze motion information of the objects changing with a time zone and attribute information of the objects.

The image analyzing unit 300 may include a pixel detecting unit 310, an object extracting unit 320, a motion analyzing unit 330, and an attribute analyzing unit 340, as illustrated in FIG. 3.

The pixel detecting unit 310 detects, from the corrected-image frame, a plurality of pixels having pixel values changing from frame to frame. That is, by differentiating a frame in a time zone t and a frame in a time zone (t+1), the pixel detecting unit 310 extracts pixels having pixel values that change by a threshold value or more.

The object extracting unit 320 connects the plurality of pixels detected by the pixel detecting unit 310 in top/bottom/left/right directions to extract region information of objects in a quadrilateral form. That is, the object extracting unit 320 extracts a quadrilateral form based on outermost located pixels by connecting pixels having pixel values that change by a threshold value or more in top/bottom/left/right directions. However, the object extracting unit 320 determines, as the same object, an object having a pixel region that is best matched with region information of an object extracted from a frame in a previous time zone, out of region information of objects extracted from a frame in a time zone (t+2), and updates region information of the objects for each time zone.

The motion analyzing unit 330 analyzes the motion information of the objects based on a form in which the region information of the objects extracted by the object extracting unit 320 changes from frame to frame in the corrected-image frame.

The attribute analyzing unit 340 analyzes attribute information of the objects extracted by the object extracting unit 330 based on the region information of the extracted objects to identify the objects. That is, the players and the ball are distinguished based on pixel sizes indicated on the region information of the objects, and the players are identified as the first team and the second team based on pixel values indicated on region information of objects other than the object identified as the ball.

Next, the 2D mini-map generating unit 400 displays the line information and the region information of the objects, which are shown on the corrected-image frame generated by the image correcting unit 200, thus generating a 2D mini-map.

Herein, the 2D mini-map generating unit 400 may include a background image generating unit 410, a line display unit 420, and an object display unit 430, as illustrated in FIG. 4.

The background image generating unit 410 generates a background image frame having a size corresponding to the corrected image frame.

The line display unit 420 displays the line information on the background image frame. The line information is displayed at a particular position on the background image frame, because of having no change.

The object display unit 430 displays the region information of the objects on the background image frame in which the line information is displayed. However, the region information of the objects on the corrected-image frame changes from frame to frame, such that the region information of the objects displayed on the background image frame is also displayed corresponding to the motion information and the attribute information of the objects.

The feature region display unit 500 displays a feature region distinctively on the 2D mini-map generated by the 2D mini-map generating unit 400, based on the attribute information of the objects.

The feature region is a region where positions of the players shown on the relay broadcast image broadcast from the broadcasting station during sports broadcasting are predicted, highlighting a position of the relay broadcast image on the 2D mini-map.

The feature region display unit 500 may include an object identifying unit 510, a region dividing unit 520, and a pixel value changing unit 530, as illustrated in FIG. 5.

The object identifying unit 510 compares pixel sizes of the region information of the objects to identify an object having the smallest pixel size as a ball. That is, the object, which is the ball, is identified among the objects including the players and the ball.

The region dividing unit 520 divides the field into a first region including the object identified as the ball and a second region. The feature region is the first region, and the remaining region other than the feature region is the second region.

The pixel value changing unit 530 changes pixel values of the first region to distinguish the first region from the second region. That is, the first region is displayed distinctively from the second region by inverting the pixel values of the first region or changing the pixel values of the first region differently from pixel values of the second region.

The 3D transforming unit 600 transforms the 2D mini-map into the 3D mini-map by replacing, with 3D region information, the region information of the objects shown on the 2D mini-map displayed in such a way that the first region and the second region are distinguished from each other.

The 3D transforming unit 600 may include a vector storing unit 610, a vector matching unit 620, and a vector mapping unit 630, as illustrated in FIG. 6.

The vector storing unit 610 stores a plurality of 3D vector information. In the 3D vector information, 3D vector information regarding players of the first team, players of the second team, and the ball, which are determined by the attribute information of the objects, is preset.

The vector matching unit 620 matches 3D vector information to the attribute information of the objects, out of the plurality of 3D vector information. Thus, first 3D vector information is matched to an object identified as a player of the first team according to the attribute information of the objects; second 3D vector information is matched to an object identified as a player of the second team; and third 3D vector information is matched to the object identified as the ball.

The vector mapping unit 630 applies the 3D vector information to the region information of the objects to replace the 3D vector information with the 3D region information. Thus, the 2D mini-map is transformed into the 3D mini-map through the mapping of the 3D region information.

Accordingly, the present invention may provide a 3D mini-map allowing a viewer to easily recognize a position of every player in the field.

The apparatus for providing the 3D mini-map service for sports broadcasting according to an exemplary embodiment of the present invention may further include a relay broadcasting image receiving unit 700 and an image merging unit 800, as illustrated in FIG. 1.

The relay broadcast image receiving unit 700 receives the relay broadcast image of the field, broadcast from the broadcasting station. The image merging unit 800 reduces the size of the 3D mini-map generated by the 3D transforming unit 600 to a preset size to overlap the 3D mini-map on the relay broadcast image received by the relay broadcast image receiving unit 700 based on preset pixel coordinate values of the relay broadcast image, thereby merging the relay broadcast image with the 3D mini-map.

Thus, the present invention may provide a relay broadcast image including a 3D mini-map that is overlapped onto the relay broadcasting image.

In addition, the apparatus for providing the 3D mini-map service for sports broadcasting according to an exemplary embodiment of the present invention may further include an image broadcasting unit 900 as illustrated in FIG. 1.

The image broadcasting unit 900 broadcasts the relay broadcast image merged with the 3D mini-map by the image merging unit 800 through the broadcasting station.

Accordingly, the present invention may broadcast and provide the relay broadcast image including the 3D mini-map to a TV, a cellular phone, or the like through a broadcasting station.

As described above, the present invention generates a 3D mini-map showing a position of every player in the field during sports broadcasting, and provides the generated 3D mini-map together with a relay broadcast image, allowing a viewer to check positions of players not shown on the relay broadcast image from the 3D mini-map to improve the quality of sports broadcasting, and thus increasing viewer's interest.

Other effects that may be obtained or expected from the embodiment of the present invention are explicitly or implicitly disclosed in the detailed description of the embodiment of the present invention. For example, various effects expected from the embodiments of the present invention have been disclosed in the detailed description of the present invention.

Although the exemplary embodiment of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for providing a three-dimensional (3D) mini-map service for sports broadcasting, the apparatus comprising:
an image obtaining unit configured to obtain a field image frame by imaging a field in which objects including a plurality of players and one ball exist, in such a way to include a line of the field;
an image correcting unit configured to extract line information by tracking the line included in the field image frame obtained by the image obtaining unit, and to generate a corrected-image frame by correcting distortion of the field image frame using the extracted line information;
an image analyzing unit configured to extract region information of the objects shown on the corrected-image frame generated by the image correcting unit and to analyze attribute information of the objects together with motion information of the objects from the extracted region information of the objects;
a mini-map generating unit configured to generate a two-dimensional (2D) mini-map by displaying the region information of the objects together with the line information shown on the corrected-image frame generated by the image correcting unit in such a way to correspond to the motion information of the objects and the attribute information of the objects;
a feature region display unit configured to display, on the 2D mini-map generated by the 2D mini-map generating unit, a first region including region information of an object identified as the ball among the objects based on the attribute information of the objects, and a second region, which is a remaining region other than the first region, in such a way to distinguish the first region from the second region; and
a 3D transforming unit configured to transform the 2D mini-map into the 3D mini-map by replacing the region information of the objects shown on the 2D mini-map in which the first region and the second region are displayed distinctively from each other by the feature region display unit, with 3D region information using 3D vector information that is preset corresponding to the attribute information of the objects.

2. The apparatus of claim 1, further comprising:
a relay broadcast image receiving unit configured to receive a relay broadcast image of the field, which is broadcast from a broadcasting station; and
an image merging unit configured to merge the relay broadcast image received by the relay broadcast image receiving unit with the 3D mini-map generated by the 3D transforming unit in such a way that the relay broadcast image includes the 3D mini-map, by reducing a size of the 3D mini-map to a preset size and overlapping the size-reduced 3D mini-map on the relay broadcast image based on preset pixel coordinate values of the relay broadcast image.

3. The apparatus of claim 2, further comprising an image broadcasting unit configured to broadcast the relay broadcast image including the 3D mini-map, merged by the image merging unit, through the broadcasting station.

4. The apparatus of claim 1, wherein the image correcting unit comprises:
an image transforming unit configured to transform the field image frame into a binary image frame based on a preset threshold value;
a line extracting unit configured to extract the line information by tracking the line shown on a specific position in each frame from the binary image frame transformed by the image transforming unit;
a distortion information analyzing unit configured to analyze distortion information of the field image frame based on the line information extracted by the line extracting unit; and
a corrected-image generating unit configured to generate the corrected-image frame by correcting the field image frame to correspond to the distortion information analyzed by the distortion information analyzing unit.

5. The apparatus of claim 1, wherein the image analyzing unit comprises:
a pixel detecting unit configured to detect a plurality of pixels having pixel values changing with a frame on a pixel region of the field image frame;
an object extracting unit configured to extract the region information of the objects in a quadrilateral form by connecting the plurality of pixels detected by the pixel detecting unit in top/bottom/left/right directions;
a motion analyzing unit configured to analyze the motion information of the objects based on a form in which the region information of the objects extracted by the object extracting unit changes with a frame of the field image frame; and
an attribute analyzing unit configured to analyze the attribute information of the objects based on pixel sizes and the pixel values of the region information of the objects extracted by the object extracting unit.

6. The apparatus of claim 1, wherein the 2D mini-map generating unit comprises:
a background image generating unit configured to generate a background image frame having a size corresponding to the corrected-image frame;
a line display unit configured to display the line information on the background image frame generated by the background image generating unit; and
an object display unit configured to display the region information of the objects on the background image frame generated by the background image generating unit in such a way to correspond to the motion information of the objects and the attribute information of the objects.

7. The apparatus of claim 1, wherein the feature region display unit comprises:
an object identifying unit configured to compare pixel sizes of the region information of the objects and to identify an object having the smallest size as the ball;
a region dividing unit configured to divide the field into the first region including the object identified as the ball by the object identifying unit and the second region, which is a remaining region other than the first region; and
a pixel value changing unit configured to change the pixel values of the first region divided by the region dividing unit in such a way to distinguish the first region from the second region.

8. The apparatus of claim 1, wherein the 3D transforming unit comprises:
a vector storing unit configured to store a plurality of pieces of 3D vector information;
a vector matching unit configured to match 3D vector information corresponding to the attribute information of the objects among the plurality of pieces of 3D vector information stored in the vector storing unit; and
a vector mapping unit configured to replace the 3D vector information matched by the vector matching unit with 3D region information by applying the matched 3D vector information to the region information of the objects.
